(19) United States
(12) Patent Application Publication
(10) Pub. No.: US 2026/0358194 A1
(43) Pub. Date: Nov. 12, 2026

(54) HOLLOW-CORE OPTICAL FIBER CHARACTERIZATION

(71) Applicant: CORNING INCORPORATED, CORNING, NY (US)

(72) Inventors: Chams Baker, Corning, NY (US); Paulo Clovis Dainese, JR., Painted Post, NY (US); John Lawrence Nord, Painted Post, NY (US)

(21) Appl. No.: 19/665,336

(22) Filed: May 1, 2026

Related U.S. Application Data
(60) Provisional application No. 63/801,477, filed on May 7, 2025.

(51) Int. Cl. G01M 11/00; G02B 6/02

(52) U.S. Cl. CPC G01M 11/35; G02B 6/02328

(57) ABSTRACT

A method of characterizing a hollow-core optical fiber having a centerline, a cladding, and a capillary fused to the cladding may include: directing a light beam from a light source to the hollow-core optical fiber, and detecting, by a photodetector, interference over a range of an angular location of the capillary about the centerline of the hollow-core optical fiber, the interference being generated in part by a portion of the light beam propagating through a path through the capillary in whispering gallery mode. The method may further include comparing a representation of the detected interference to a representation of simulated interference, and determining, based on the comparison, at least one of a cladding inner diameter, an overlap width between the capillary and the cladding, or an effective-interface-capillary inner diameter. The method may further include determining an intersection angle between the capillary and the cladding based on the detected interference.

### CROSS-REFERENCE TO RELATED APPLICATIONS

This application claims the benefit of priority of U.S. Provisional Application Ser. No. 63/801,477, filed on May 7, 2025, the content of which is relied upon and incorporated herein by reference in its entirety.

### FIELD

The present disclosure generally relates to characterizing optical fibers, and more specifically, to characterizing hollow-core optical fibers.

### BACKGROUND

Hollow-core optical fibers are an emerging class of optical fibers gaining attention due to their potentially low attenuation and very low latency. The internal microstructure of a hollow-core optical fiber, such as the dimensions and/or locations of the structural features in the hollow-core optical fiber, is important because it dictates how well light will travel down the hollow-core optical fiber. Accordingly, there is a need to characterize the internal structural features of the hollow-core optical fiber.

### SUMMARY

In some embodiments, a method of characterizing a hollow-core optical fiber comprising a centerline, a cladding, and a capillary a portion of which is fused to the cladding may include: directing a light beam from a light source to the hollow-core optical fiber; and detecting, by a photodetector, interference generated at least in part by a portion of the light beam propagating through a path through the capillary, wherein the path through the capillary is defined at least in part by a portion of the capillary not fused to the cladding. In some embodiments, the method may include comparing a representation of the detected interference to a representation of simulated interference of a simulated hollow-core optical fiber, wherein the representation of the detected interference comprises at least one of a V-shaped pattern or a V-shaped curve, and wherein the representation of the simulated interference comprises at least one of a V-shaped pattern or a V-shaped curve. In some embodiments, the method may further include determining, based on the comparison, at least one of a cladding inner diameter, a capillary overlap width, or an effective-interface-capillary inner diameter. The cladding inner diameter is defined as a radial distance between the centerline of the hollow-core optical fiber and an inner surface of the cladding. The capillary overlap width is defined as a distance between two intersection points between which the portion of the capillary fused to the cladding extends. The effective-interface-capillary inner diameter is defined by an inner surface of the portion of the capillary fused to the cladding.

In some embodiments, a method of characterizing a hollow-core optical fiber comprising a centerline, a cladding, and a capillary a portion of which is fused to the cladding and extends between two intersection points may include directing a light beam from a light source to the hollow-core optical fiber; and detecting, by a photodetector, interference generated at least in part by a portion of the light beam propagating through a path through the capillary in whispering gallery mode and a portion of the light beam reflected via internal reflection by an inner surface of the portion of the capillary fused to the cladding. In some embodiments, the method may further include adjusting at least one of an angular location of the light source, an angular location of the photodetector, or an angular location of the capillary of the hollow-core optical fiber about the centerline of the hollow-core optical fiber such that an angular intensity distribution of the detected interference is symmetrical about a maximum intensity of the detected interference.

In some embodiments, a method of characterizing a hollow-core optical fiber comprising a cladding and a capillary, the cladding having a cladding inner diameter, and the capillary comprising an unfused portion that is not fused to the cladding and has a capillary inner diameter and a fused portion that is fused to the cladding and has an effective-interface-capillary inner diameter greater than the capillary inner diameter and less than the cladding inner diameter, may include: directing a light beam from a light source to the hollow-core optical fiber; detecting, by a photodetector, interference generated at least in part by a portion of the light beam propagating through a path through the capillary and/or a portion of the light beam reflected via internal reflection by an inner surface of the fused portion of the capillary and adjacent inner surface portions of the cladding not fused to the capillary; comparing a representation of the detected interference to a representation of simulated interference of a simulated hollow-core optical fiber; and determining, based on the comparison, the effective-interface-capillary inner diameter of the hollow-core optical fiber being characterized. In some embodiments, the simulated hollow-core optical fiber comprises a simulated cladding and a simulated capillary, the simulated cladding having a simulated cladding inner diameter, and the simulated capillary comprising a simulated unfused portion that is not fused to the simulated cladding and has a simulated capillary inner diameter and a simulated fused portion that is fused to the simulated cladding and has a simulated effective-interface-capillary inner diameter greater than the simulated capillary inner diameter and less than the simulated cladding inner diameter. In some embodiments, the representation of the simulated interference may be obtained at least in part by calculating a simulated base field E_{base} based on the following: E_{base}=E_{cap,section}+E_{cl,section_1}+E_{cl,section_2}, where E_{cap,section} represents a simulated capillary field due to internal reflection by a simulated inner surface of the simulated fused portion of the simulated capillary, wherein the simulated inner surface of the simulated fused portion of the simulated capillary defines the simulated effective-interface-capillary inner diameter, and E_{cl,section_1}+E_{cl,section_2} represents a simulated cladding field due to internal reflection by simulated inner surface portions of the simulated cladding disposed on either side of the simulated fused portion of the simulated capillary.

Additional features and advantages are set forth in the Detailed Description that follows, and in part will be readily apparent to those skilled in the art from the description or recognized by practicing the embodiments as described in the written description and claims hereof, as well as the appended drawings. It is to be understood that both the foregoing general description and the following Detailed Description are merely exemplary, and are intended to provide an overview or framework to understand the nature and character of the claims.

### BRIEF DESCRIPTION OF THE DRAWINGS

The accompanying drawings are included to provide a further understanding, and are incorporated in and constitute a part of this specification. The drawings illustrate one or more embodiment(s), and together with the Detailed Description serve to explain principles and operation of the various embodiments. As such, the disclosure will become more fully understood from the following Detailed Description, taken in conjunction with the accompanying figures.

FIG. 1A schematically illustrates a cross-sectional view of an exemplary hollow-core optical fiber.

FIG. 1B schematically illustrates a cross-sectional view of another exemplary hollow-core optical fiber.

FIG. 2 schematically illustrates a system for characterizing a hollow-core optical fiber.

FIGS. 3A and 3B schematically illustrate two paths of light propagating through a hollow-core optical fiber that can be characterized by the system of FIG. 2.

FIG. 4A schematically illustrates sections of glass-air interfaces formed by inner surface portions of a cladding and a capillary of a hollow-core optical fiber.

FIG. 4B schematically illustrates sections of glass-air interfaces formed by inner surface portions of a cladding, a capillary, and a nested capillary of a hollow-core optical fiber.

FIG. 5 shows an interference pattern of a base field represented by intensity as a function of angular location of a capillary of a hollow-core optical fiber.

FIG. 6 shows an intensity pattern of a base field in the absence of any capillary.

FIG. 7 shows wavelength dependence of the interference pattern of the base field of FIG. 5 as a function of angular location of a capillary.

FIG. 8 shows wavelength dependence of total intensity as a function of angular location of a capillary, with in-capillary propagating field included.

FIG. 9 shows a result of Fourier transform of the intensity pattern of FIG. 8.

FIG. 10 shows a result of the intensity pattern of FIG. 9 by replacing group delay with nominal path-length diameter.

FIG. 11A schematically illustrates light from a light source propagating through a hollow-core optical fiber having a cladding and a capillary to a photodetector when the capillary is located away from the point where a minimum optical path meets a glass-air interface defined by an inner surface of the cladding.

FIG. 11B schematically illustrates light from a light source propagating through a hollow-core optical fiber having a cladding and a capillary to a photodetector when the capillary is located at the point where a minimum optical path meets a glass-air interface defined by an inner surface of the capillary.

FIG. 12 is a top view of FIG. 8, which shows V-shaped interference patterns.

FIGS. 13A and 13B show measured and simulated interference patterns, respectively, as a function of angular location of a capillary.

FIG. 14 shows simulated V-shaped patterns for two hollow-core optical fibers having different cladding inner diameters.

FIGS. 15A and 15B show close agreement between analytically calculated and numerically calculated interference patterns.

FIG. 16 is a scanning electron microscope image of a portion of a hollow-core optical fiber showing a capillary/cladding interface.

FIG. 17A schematically illustrates light from a light source propagating through a hollow-core optical fiber having a capillary to a photodetector when the photodetector is not aligned at a maximum peak intensity point of the light that exits the capillary.

FIG. 17B schematically illustrates light from a light source propagating through a hollow-core optical fiber having a capillary to a photodetector when the photodetector is aligned at a maximum peak intensity point of the light that exits the capillary.

FIG. 18 shows an angular intensity distribution of a V-shaped pattern as a function of nominal path-length diameter, obtained using the light source and photodetector configuration shown in FIG. 17A.

FIG. 19 schematically illustrates a hollow-core optical fiber having a capillary and a cladding with the capillary tangentially touching the cladding, and a hollow-core optical fiber having a capillary and a cladding with the capillary overlapping with the cladding.

FIG. 20 schematically illustrates a hollow-core optical fiber with an effective-interface capillary.

FIG. 21 is a scanning electron microscope image showing a capillary fused to a cladding of a hollow-core optical fiber.

FIG. 22 is an enlarged portion of the scanning electron microscope image of FIG. 21 showing the outer circumference of the non-overlapping portion of the capillary fitted with an ellipse.

FIG. 23 is an enlarged portion of the scanning electron microscope image of FIG. 21 showing the capillary/cladding interface.

FIGS. 24A and 24B show exemplary simulation and measured results, respectively, having close agreement with each other.

FIG. 25 schematically illustrates an exemplary process for drawing a hollow-core optical fiber.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “≤” are used interchangeably, “greater than” and “>” are used interchangeably, and “less than” and “<” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

When terms, such as “circular,” “square,” “linear,” “parallel,” “perpendicular,” “tangential,” “symmetrical,” “congruent,” “identical,” “coaxial,” “concentric,” “equiangular,” “equidistant,” etc., are used to describe geometrical properties, it is understood that actual geometrical properties may vary or deviate from these precise conditions due to factors including, but not limited to, manufacturing limitations or tolerances, material properties, environmental conditions, measurement inaccuracies, and so on. Thus, while the terms imply precise geometric properties, practical application acknowledges and permits minor discrepancies.

Directional terms as used herein—for example up, down, right, left, front, back, top, bottom—are made only with reference to the figures as drawn and are not intended to imply absolute orientation.

Various components described herein may be referred to as “directly connected” or “indirectly connected.” Components are directly connected when they are joined to one another with no intervening structure. Components may be joined by fusing, melting, welding, soldering, adhesives, or any other suitable attachment means. Components are “indirectly connected” when they are joined to one another with intervening structure. Examples of intervening structure include welding aids (e.g., frits, solders, fluxes), adhesives, and bonding materials. In some embodiments, components connected indirectly are connected only by a welding aid, adhesive, or bonding material. The term “connected” means “directly connected” or “indirectly connected.” Components “directly connected” to one another are said to be in direct contact with each other. Components “indirectly connected” to one another are said to be in indirect contact with each other. Components “connected” to one another are in direct or indirect contact with each other.

As used herein, the terms “upstream” and “downstream” refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation.

As used herein, the term “linear” refers to relative distances/lengths between points. A “linear” distance/length may refer to a distance between two points along a straight line.

As used herein, the singular forms “a,” “an” and “the” include plural referents in addition to the single referent unless the context clearly dictates otherwise. Thus, for example, reference to “a” component includes aspects having one such component as well as two or more such components, unless the context clearly indicates otherwise.

Reference will now be made in detail to various embodiments. Whenever possible, the same reference numerals will be used throughout the drawings to refer to the same or like parts.

### Hollow-Core Optical Fiber

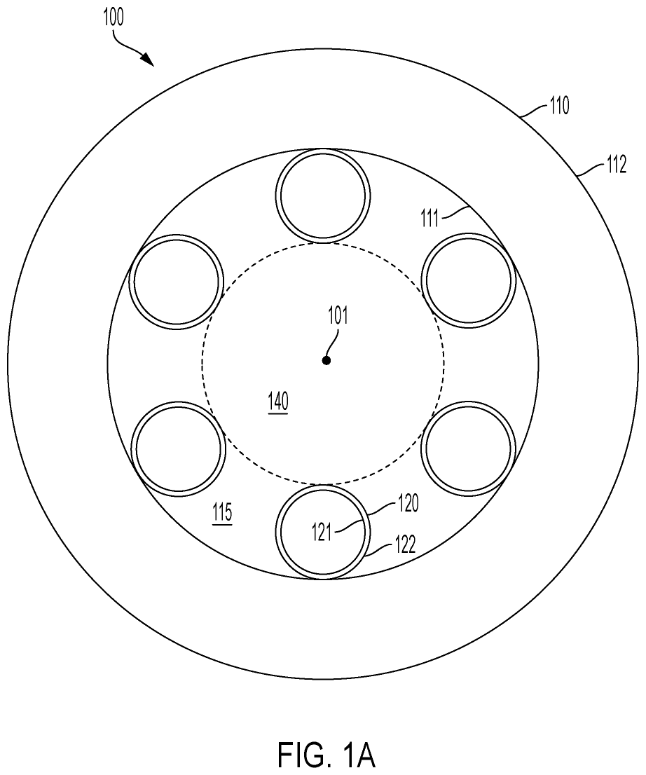

FIG. 1A schematically illustrates a cross-sectional view of an exemplary hollow-core optical fiber 100 having a centerline 101. The hollow-core optical fiber 100 may include a cladding 110. The cladding 110 may include an inner surface 111 defining an interior cavity 115 and an outer surface 112. The hollow-core optical fiber 100 may further include one or more (e.g., one, two, three, four, five, six, or more) cladding elements, such as capillaries 120, inside the interior cavity 115 of the cladding 110. Each capillary 120 may include an inner surface 121 and an outer surface 122. The outer surface 122 of each capillary 120 may be in contact with the inner surface 111 of the cladding 110. The capillaries 120 may not be in contact with each other and may be evenly spaced along the inner surface 111 of the cladding 110. In some embodiments, the cladding elements of the hollow-core optical fiber 100 may also include nested capillaries 130 each disposed inside a capillary 120, such as shown in FIG. 1B. Each nested capillary 130 may include an inner surface 131 and an outer surface 132. The outer surface 132 of each nested capillary 130 may be in contact with the inner surface 121 of the capillary 120. Although only one nested capillary 130 is shown inside each capillary 120, the number of nested capillaries is not limited to one inside each capillary 120. In some embodiments, more than one nested capillary may be arranged inside each capillary 120, and in some embodiments, such more than one nested capillary may be nested inside the capillary 120 or may be further nested inside the nested capillary 130 and so forth. The cladding elements may surround and define a hollow core 140 of the hollow-core optical fiber 100. The hollow core 140 may be the central portion of the interior cavity 115 and may correspond to the region of the hollow-core optical fiber 100 in which optical signals may be primarily confined and propagate. In some embodiments, the cladding 110 and/or the cladding elements may include silica glass and/or silica-based glass (i.e., silica glass comprising one or more dopants).

### Characterization System

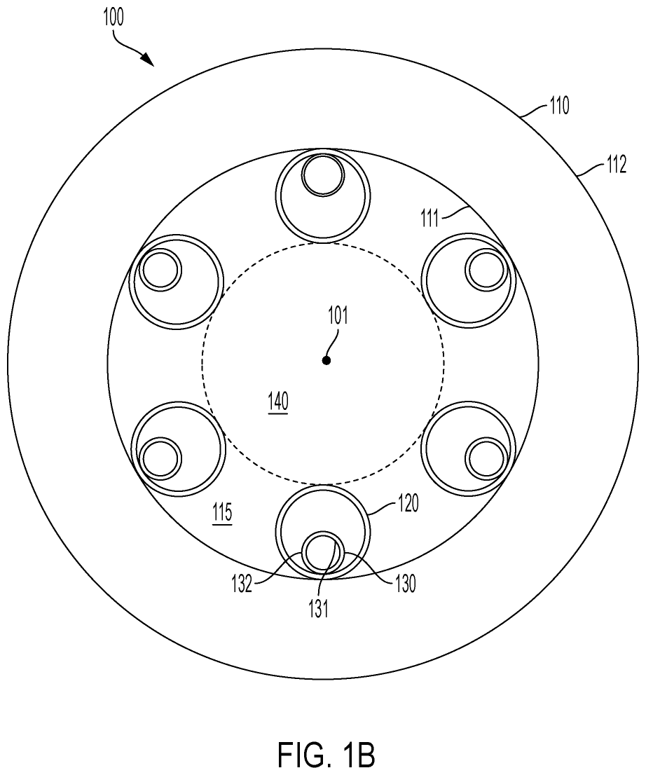

FIG. 2 schematically illustrates a system 200 for characterizing the hollow-core optical fiber 100. In FIG. 2, although only one capillary 120 is shown for illustrative purpose, the hollow-core optical fiber 100 may include multiple capillaries 120 as discussed above, and the characterization of the one capillary 120 described below applies to any other capillaries 120 of the hollow-core optical fiber 100. Further, although no nested capillaries are shown in FIG. 2, the characterization described below also applies to hollow-core optical fibers having nested capillaries as would be appreciated by one skilled in the art.

The system 200 may include a light source 210 and a photodetector 220. The light source 210 may include a broadband light source and may be configured to direct a light beam, more specifically, collimated light beam towards the hollow-core optical fiber 100 in the wavelength range of from 350 nm to 1900 nm—including all sub-ranges or values therebetween. For example, in some embodiments, the collimated light beam may be in the wavelength range from 350 nm to 1900 nm, from 350 nm to 1550 nm, from 350 nm to 1200 nm, from 350 nm to 800 nm, from 400 nm to 1900 nm, from 400 nm to 1550 nm, from 400 nm to 1200 nm, from 400 nm to 800 nm, from 600 nm to 1900 nm, from 600 nm to 1550 nm, from 600 nm to 1200 nm, or from 600 nm to 800 nm.

The photodetector 220 may be configured to detect light, more specifically, interference pattern as will be discussed in more detail below, after the light passes through (e.g., reflected by and/or refracted by) the hollow-core optical fiber 100. In some embodiments, the hollow-core optical fiber 100 may rotate about its centerline 101 for characterization. Thus, the capillary 120 may be rotated to various angular locations from 0 degree as shown in FIG. 2, which correspond to the direction of the light beam output from the light source 210. In some embodiments, the photodetector 220 may be positioned at a predetermined angular location from the centerline 101 of the hollow-core optical fiber 100 as the hollow-core optical fiber 100 may be rotated. In some embodiments, instead of or in addition to rotating the hollow-core optical fiber 100, the photodetector 220 may be rotated about the centerline 101 of the hollow-core optical fiber 100. In some embodiments, instead of or in addition to rotating at least one of the hollow-core optical fiber 100 and/or the photodetector 220, the light source 210 may be configured to rotate about the centerline of the hollow-core optical fiber 100 to various angular locations. In some embodiments, the system 200 may include multiple photodetectors 220 positioned at various angular locations for characterizing the hollow-core optical fiber 100. In some embodiments, one or more of the multiple photodetectors 220 may be configured to rotate about the centerline 101 of the hollow-core optical fiber 100. In some embodiments, the system 200 may include multiple light sources 210 positioned at various angular locations for directing light beams towards the hollow-core optical fiber for characterizing the hollow-core optical fiber 100. In some embodiments, one or more of the multiple photodetectors 220 may be configured to rotate about the centerline 101 of the hollow-core optical fiber 100. As would be appreciated by one skilled in the art, various configurations of the system 200 may be implemented for characterizing the hollow-core optical fiber 100 using the methods described herein based at least in part on the dependence of the detected interference on the angular location of the capillary 120 of the hollow-core optical fiber 100, as will be discussed in more detail below.

### Interference and Simulation Using Path Integral Method

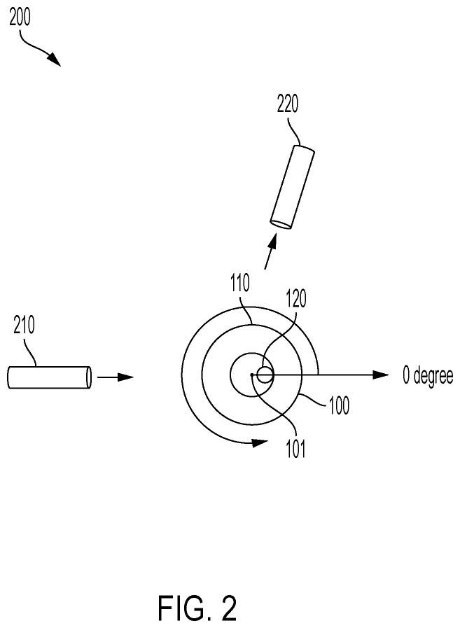

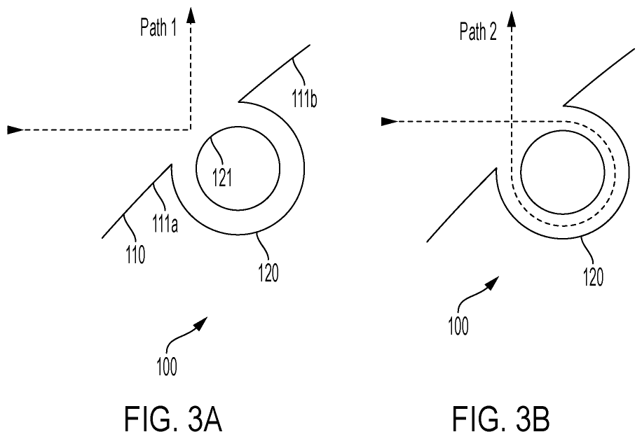

FIGS. 3A and 3B schematically illustrate two paths of light propagating through the hollow-core optical fiber 100. In FIGS. 3A and 3B, only portions of the hollow-core optical fiber 100, specifically, the inner surface 111 of the cladding 110 and the capillary 120, are shown. As shown in FIG. 3A, path 1 schematically represents a fraction of the incident light from the light source 210 that is reflected by the glass-air interface, which is formed by the inner surface portions 111a, 111b of the cladding 110 and the inner surface 121 of the capillary 120, as also schematically shown in FIG. 4A. As shown in FIG. 3B, a fraction of the incident light, schematically represented by path 2, couples into the capillary 120, propagates along the capillary 120 in Whispering Gallery mode, and then exits the capillary 120. The photodetector 220 therefore detects the superposition or interference of light from the capillary 120 with a strong base signal from the specular reflection by the inner surface portions 111a, 111b of the cladding 110 and the inner surface 121 of the capillary 120. In some embodiments, the system 200 may be an interferometer, e.g., Mach-Zehnder interferometer, for observing the interference effect due to the incident light splits into path 1 and path 2.

Assume the base signal (corresponding to path 1 shown in FIG. 3A) has an electric field E_{base} and the signal from the capillary 120 (corresponding to path 2 shown in FIG. 3B) has a small electric field ε_{cap}, then the total electric field Eₜₒₜₐₗ is given by:

Eₜₒₜₐₗ=E_{base}+ε_{cap} (1)

and the total intensity is given by:

Iₜₒₜₐₗ∝|E_{base}+ε_{cap}|²=|E_{base}|²+|ε_{cap}|²+2|E_{base}∥ε_{cap}|cos(Δφ) (2)

where Δφ=φ_{cap}−φ_{base}, and φ_{cap} and φ_{base} are the phase of the field that traveled through the capillary 120 and the phase of the base signal, respectively. The intensity of the signal from the capillary 120 is very small, and hence |ε_{cap}|² can be omitted, leading to:

Iₜₒₜₐₗ∝|E_{base}|²+2|E_{base}∥ε_{cap}|cos(Δφ) (3)

It should be noted that the effect of the signal that propagates in the capillary 120, although small, can be detected because it is magnified by the base field as can be seen in the term 2|E_{base}∥ε_{cap}|.

Illuminating the hollow-core optical fiber 100 with the broadband light source 210 leads to fringes in the detected spectrum or interference pattern. With υ=c/λ being the optical frequency, c is the speed of light traveling in vacuum, λ is the optical wavelength, the separation Δυ between two peaks in the detected spectrum or interference pattern is obtained when the phase difference between the two peaks equals to 2π, represented as follows:

Δφ=β_{cap}(ω₁+Δω)L_{cap}−β_{cap}(ω₁)L_{cap}=2π (4)

where β_{cap}(ω₁)L_{cap} represents the phase at one peak, β_{cap}(ω₁+Δω)L_{cap} represents the phase at the adjacent peak, β_{cap} is the propagation constant of the capillary 120, ω₁=2π υ₁ is the angular frequency, Δω represents the separation between the two peaks with Δω=2π Δυ, and L_{cap} represents the path length through the capillary 120 and L_{cap}=πd_{cap}, where d_{cap} is the diameter of the path with length L_{cap} through the capillary 120 (also referred to as the capillary-path-length diameter d_{cap}).

Based on Equation (4), the following is obtained:

$$[ {β}_{cap} ( {ω}_{1} + Δ ω ) - {β}_{cap} ( {ω}_{1} ) ] {L}_{cap} = 2 π \qquad ( 5 )$$

$$\frac{[ {β}_{cap} ( {ω}_{1} + Δ ω ) - {β}_{cap} ( {ω}_{1} ) ]}{Δ ω} Δ ω {L}_{cap} = 2 π \qquad ( 6 )$$

$$\frac{\partial {β}_{cap}}{\partial ω} Δ ω {L}_{cap} = 2 π \qquad ( 7 )$$

$$\frac{1}{{v}_{g , cap}} Δ ω {L}_{cap} = 2 π \qquad ( 8 )$$

$$\frac{1}{{v}_{g , cap}} Δ v {L}_{cap} = 1 \qquad ( 9 )$$

$$\frac{{L}_{cap}}{{v}_{g , cap}} = \frac{1}{Δ v} \qquad ( 10 )$$

where v_{g,cap} is the group velocity of light traveling through the capillary 120 and

$${v}_{g , cap} = \frac{c}{{n}_{g , cap}}$$

where c is the speed light traveling in vacuum and n_{g,cap} is the group refractive index of the material forming the capillary 120. Since Δυ is the separation between two consecutive peaks in the interference pattern and the interference patterns has cyclical behavior,

$$\frac{1}{Δ v}$$

can be obtained by taking the Fourier transform (FT) of the detected spectrum and choosing the value at which the Fourier Transform curve has a peak value.

Using the group delay τ_{g,cap}=L_{cap}/v_{g,cap} leads to

$${τ}_{g , cap} = \frac{1}{Δ v} \qquad ( 11 )$$

Thus, the Fourier transform (FT) of the detected spectrum (expressed as a function of optical frequency υ rather than optical wavelength λ) allows for the calculation of the group delay τ_{g,cap}. The value of L_{cap} represents the path length through the capillary 120, and hence:

$${L}_{cap} = {v}_{g , {cap}^{T} g , cap} \qquad ( 12 )$$

$${L}_{cap} = \frac{c}{{n}_{g , cap}} {τ}_{g , cap} \qquad ( 13 )$$

Using the diameter d_{cap} of the path with length L_{cap} through the capillary 120 leads to:

$${L}_{cap} = π {d}_{cap} \qquad ( 14 )$$

$${d}_{cap} = \frac{{L}_{cap}}{π} \qquad ( 15 )$$

$${d}_{cap} = \frac{1}{π} \frac{c}{{n}_{g , cap}} {τ}_{g , cap} \qquad ( 16 )$$

$${d}_{cap} = \frac{1}{π} \frac{c}{{n}_{g , cap}} \frac{1}{Δ v} \qquad ( 17 )$$

Thus, the Fourier transform (FT) of the detected spectrum allows for calculation of the diameter d_{cap} of the path with length L_{cap} through the capillary 120.

To simulate the interference effect, the photodetector 220 is assumed to be positioned at a predetermined angular location from the centerline 101 of the hollow-core optical fiber 100, and the hollow-core optical fiber 100 is rotated about the centerline 101 of the hollow-core optical fiber 100 thereby rotating the capillary 120 to a range of angular locations from the centerline 101 of the hollow-core optical fiber 100. It should be noted, however, that the simulation method described herein can also be applied when the photodetector 220 may be rotated to a range of angular locations while the hollow-core optical fiber 100 may remain stationary, or when both of the photodetector 220 and the hollow-core optical fiber 100 may be rotated.

Using a path integral method, the base signal reflected from the inner surface 111 of the cladding 110 and the inner surface 121 of the capillary 120 (as illustrated in FIG. 3A and schematically represented as arc portions in FIG. 4A) is first calculated. Specifically, the inner surfaces 111, 121, or arc portions 111a, 121, 111b in FIG. 4A, are divided into small segments acting as a scattering points, each with a length of less than the wavelength of the incident light, such as less than or equal to 0.5, less than or equal to 0.3, or less than or equal to 0.1 of the minimum wavelength of the incident light. It should be noted that the base signal itself depends on the angular location of the capillary 120, since the inner surface 111 of the cladding 110 is perturbed from an ideal circle by the portion of the inner surface 121 of the capillary 120 attached to the cladding 110. The base field is given by:

E_{base}=E_{cap,section}+E_{cl,section_1}+E_{cl,section_2} (18)

where the capillary field E_{cap,section} is obtained by summing the field from the light source 210 to the photodetector 220 passing by every point of the section of the inner surface 121 of the capillary 120 shown in FIG. 4A, and the field contributed by the cladding 110, E_{cl,section}=E_{cl,section_1}+E_{cl,section_2}, is obtained by summing the field from the light source 210 to the photodetector 220 passing by every point of the inner surface sections 111a, 111b of the cladding 110 shown in FIG. 4A. In the case where the hollow-core optical fiber 100 further includes nested capillaries 130 such as shown in FIG. 1B, FIG. 4B schematically illustrates sections of glass-air interfaces formed by the inner surface portions 111a, 111b of the cladding 110, the inner surface portions 121a, 121b of the capillary 130, and the inner surface portion 131 of the nested capillary 130 for determining the base signal reflected from the inner surface 111 of the cladding 110, the inner surface 121 of the capillary 120, and the inner surface 131 of the nested capillary 130: E_{base}=E_{nested cap,section}+E_{cap,section_1}+E_{cap,section_2}+E_{cl,section_1}+E_{cl,section_2}. It should be noted that although not shown in FIGS. 3A, 3B, 4A, and 4B, refraction at the outer interface 112 of the cladding 110 is also accounted for.

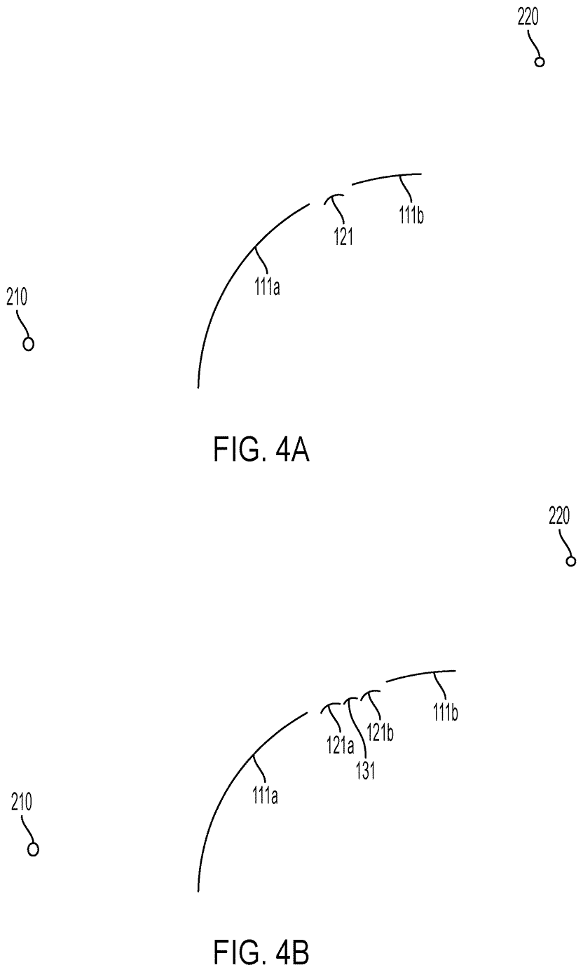

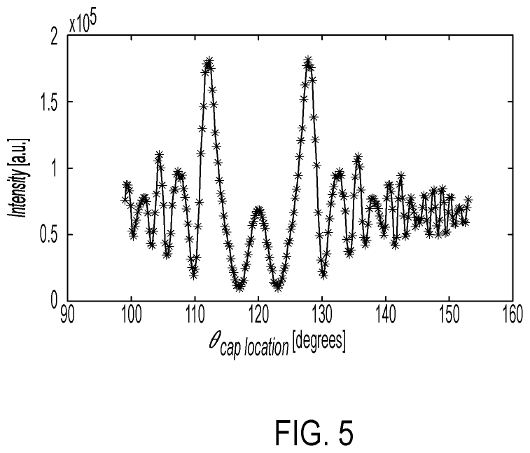

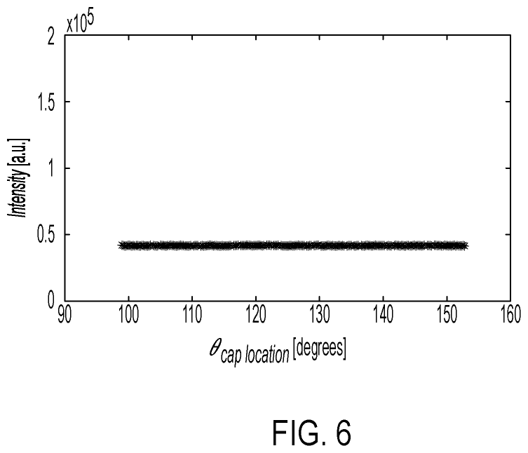

FIG. 5 shows the interference pattern of the base field represented by intensity as a function of the angular location of the capillary 120 (θ_{cap location}). FIG. 6 shows the intensity pattern of the base field in the absence of a capillary 120, indicating that the interference pattern in FIG. 5 arises from the presence of the capillary 120. The wavelength dependence of the interference pattern of the base field as a function of the angular location of the capillary 120 (θ_{cap location}) is presented in FIG. 7.

Superposing the base field with the field contribution due to propagation in the capillary 120 leads to the total field the following:

Eₜₒₜₐₗ=E_{base}+ε_{cap}=E_{cap,section}+E_{cl,section}+ε_{cap} (19)

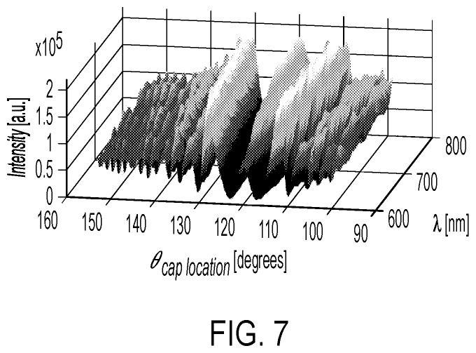

FIG. 8 shows the wavelength dependence of total intensity |Eₜₒₜₐₗ|² as a function of the angular location of the capillary 120, with the in-capillary propagating field included.

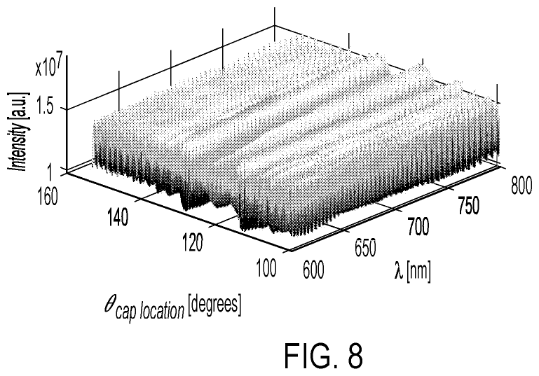

FIG. 8 shows that the detected spectrum contains a high frequency component arising from the delay as light propagate through the capillary 120, superimposed with a broader interference spectrum arising from the based signal. As discussed above and based on Equation (11), the frequency of the wavelength dependent oscillation is related to the group delay τ_{g,cap} through the capillary 120. Therefore, taking the Fourier transform of the interference pattern in FIG. 8 allows for estimation of τ_{g,cap} as shown in FIG. 9, which shows the group delay τ_{g,cap} dependence of intensity as a function of the angular location of the capillary 120. Replacing the group delay τ_{g,cap} in FIG. 9 with a nominal path-length diameter Dₙₒₘᵢₙₐₗ using the following:

$${D}_{nominal} = \frac{1}{π} \frac{c}{{n}_{g , cap}} {τ}_{g , cap} \qquad ( 20 )$$

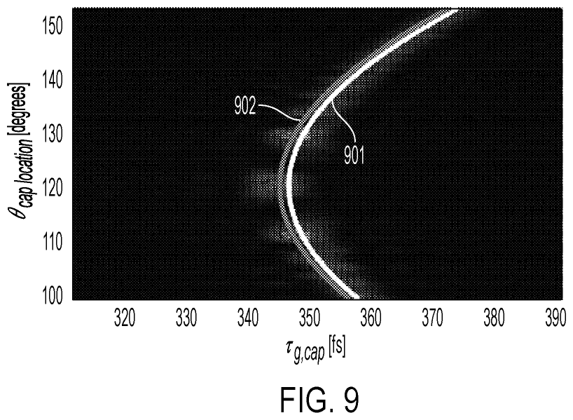

FIG. 10 is obtained. It is noted that the V-shaped patterns, or simply V patterns, formed by the simulated intensity islands in FIGS. 9 and 10 correspond to the V-shaped patterns observed in experimental measurements.

### Determining Diameter of Path Length Through Capillary

With FIGS. 9 and 10, the diameter of the path with length L_{cap} through the capillary 120, d_{cap}, can be identified. Specifically, also shown in FIGS. 9 and 10 are V-shaped curve 901, V-shaped curve 902, V-shaped curve 1001, and V-shaped curve 1002, which are estimations (discussed in more detail below) obtained by taking the optical path difference between the optical path through the capillary 120 and the minimum optical path from the glass-air interface formed by the inner surface 111 of the cladding 110 or the inner surface 121 of the capillary 120.

The minimum optical path from the glass-air interface corresponds to Fermat's principal of least time for light to travel from the light source 210 to the photodetector 220 via reflection at one point at the inner surface 111 of the cladding 110 or the inner surface 121 of the capillary 120. It should be noted that the optical path length Lₒₚ is defined as the path length L multiplied by the effective refractive index n, and thus, Lₒₚ=nL.

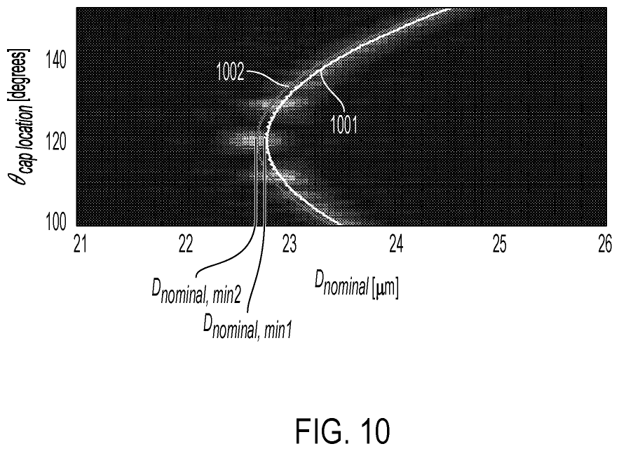

More specifically, the V-shaped curves 901, 902 represents the estimation of group delay τ_{g,cap} using a first minimum optical path and a second minimum optical path, respectively, with the second minimum optical path being slightly different from the first minimum optical path. The first minimum optical path, with length L_{op,cl-surface,min}, corresponds to the minimum optical path 1120a when the capillary 120 is located away from the point 1130a where the minimum optical path 1120a meets the glass-air interface defined by the inner surface 111 of the cladding 110, as schematically illustrated in FIG. 11A. The second minimum optical path, with length L_{op,cap-surface,min}, corresponds to the minimum optical path 1120b when the capillary 120 is located at the point 1130b where the minimum optical path 1120b meets the glass-air interface defined by the inner surface 121 of the capillary 120, as schematically illustrated in FIG. 11B. The values of L_{op,cl-surface,min} and L_{op,cap-surface,min} are calculated as follows:

L_{op,cl-surface,min}=min{L_{op,cl-surface}(x_{cl-point},y_{cl-point},θ_{cap})} (21)

L_{op,cap-surface,min}=min{L_{op,cap-surface}(x_{cap-point},y_{cap-point},θ_{cap})} (22)

where (x_{cl-point},y_{cl-point}) represents points on the inner surface portions 111a, 111b of the cladding 110, (x_{cap-point},y_{cap-point}) represents points on the inner surface 121 of the capillary 120, and θ_{cap} is the angular location of the capillary 120.

The V-shaped curve 1001 and V-shaped curve 1002 are obtained by replacing the group delay τ_{g,cap} in the V-shaped curve 901 and V-shaped curve 902, respectively, with the nominal diameter Dₙₒₘᵢₙₐₗ using Equation (20). Accordingly, the V-shaped curve 1001 is associated with the optical path difference between the optical path 1110a through the capillary 120 and the first minimum optical path 1120a when the capillary 120 is located away from the point 1130a where the minimum optical path 1120a meets the glass-air interface defined by the inner surface 111 of the cladding 110. The V-shaped curve 1002 is associated with the optical path difference between the optical path 1110b through the capillary 120 and the second minimum optical path 1120b when the capillary 120 is located at the point 1130b where the minimum path 1120b meets the glass-air interface defined by the inner surface 121 of the capillary 120.

Referring to back to FIG. 9, a minimum group delay τ_{g,cap} results when the path difference equals to the path length L_{cap} in the capillary 120. Thus, in FIG. 10, the minimum Dₙₒₘᵢₙₐₗ value D_{nominal,min1}, D_{nominal,min2} at the apex of each of the V-shaped curves 1001, 1002 can be used to estimate the diameter of the path with length L_{cap} through the capillary 120, i.e., d_{cap}, with D_{nominal,min2}≤d_{cap}≤D_{nominal,min1}.

### Determining Cladding Inner Diameter

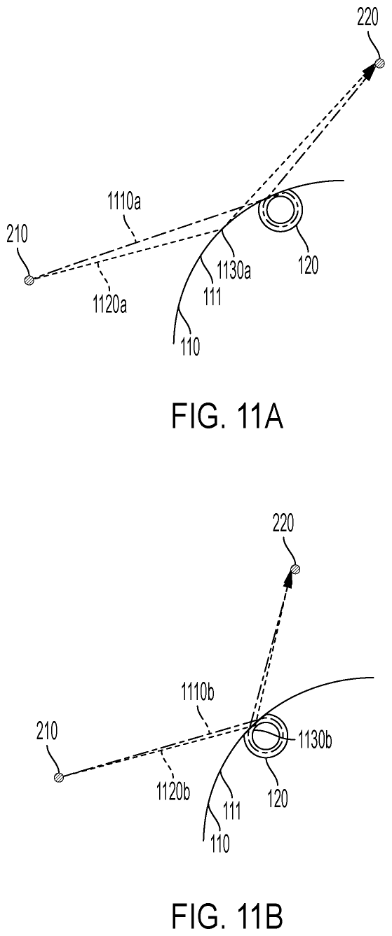

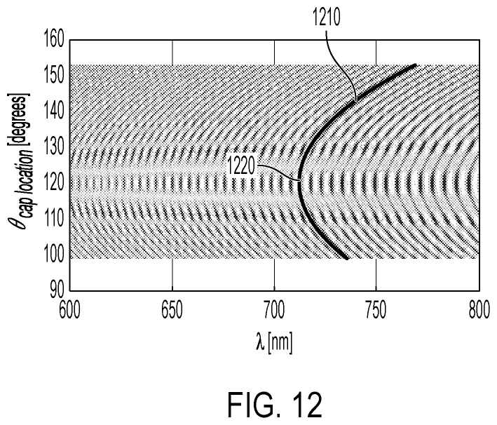

The inventors have discovered that the V shape is not only present in the Fourier transform of the interference pattern (e.g., FIG. 9), but is also present in the interference pattern. Specifically, FIG. 12 shows a top view of FIG. 8 which is the numerically calculated interference pattern obtained using the path integral method as discussed above, revealing the V shape of the interference patterns. FIGS. 13A and 13B further confirm that the V shape can also be observed in the experimentally measured interference pattern. Specifically, FIG. 13A shows the measured spectra as a function of angular location of the capillary 120, and FIG. 13B shows the simulated interference patterns, which correspond well to the measured spectra.

The V shape in the interference patterns corresponds to the following:

$${λ}_{epc} ( {θ}_{cap} ) = \frac{{L}_{o p , cap} ( {θ}_{cap} ) - {L}_{op , cl - surface , m i n}}{( n π {d}_{cap} )} {λ}_{0} \qquad ( 23 )$$

where λ_{epc} represents the wavelength values for an equi-phase curve (epc) along which the phase is constant, θ_{cap} is the angular location of the capillary 120, d_{cap} is the diameter of the path with length L_{cap} through the capillary 120, n is the effective refractive index of the corresponding slab mode in the capillary 120, L_{op,cl,min} is the length of the minimum optical path via glass-air interface reflection and corresponds to the optical path of least time, L_{op,cap}(θ_{cap}) is the length of the optical path through the capillary 120, and λ₀ is a constant wavelength value. λ₀ should be chosen to be a value within the wavelength range of the collimated light from the light source 210 because the apex of the V shape curve of Equation (23) will be located near (e.g., within 50 nm) λ₀. Thus, λ₀=700 nm is chosen to obtain the V-shaped curve 1210 in FIG. 12, with the apex 1220 of the V-shaped curve near λ₀=700 nm. As mentioned above, the optical path length Lₒₚ is defined as the path length L multiplied by the effective refractive index n, specifically, Lₒₚ=nL.

The inventors have discovered that the measured interference spectra can be utilized to determine the inner diameter of the cladding 110. The inventors have recognized that the value of L_{op,cl,min} is relatively unchanged as it corresponds to the optical path of least time, whereas the value of L_{op,cap}(θ_{cap}) depends on the inner diameter of the cladding 110. The inventors have discovered that the V-shaped patterns from the measured interference spectra can be utilized to determine the inner diameter of the cladding 110. Specifically, the inventors have discovered that for hollow-core optical fibers 100 having claddings 110 with different inner diameters, the V-shaped patterns of the measured interference spectra differ. Thus, the shapes of the V-shaped patterns can be utilized to determine the inner diameter of the cladding 110.

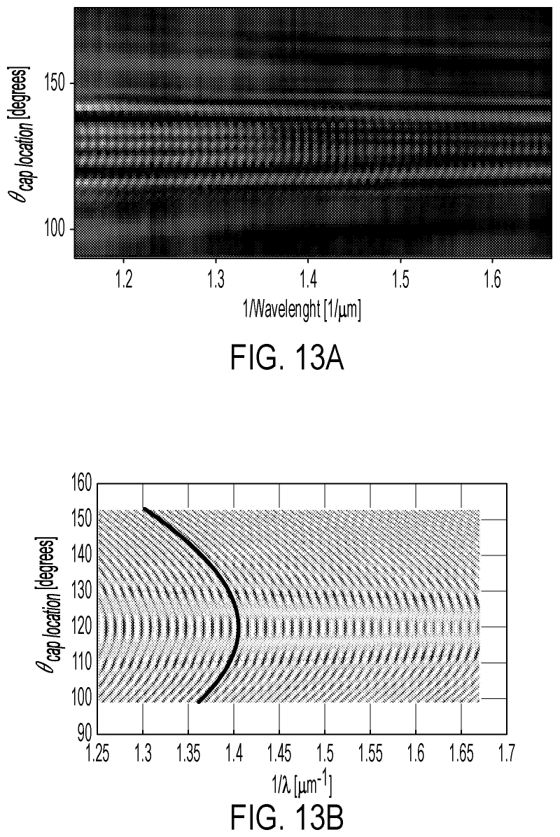

FIG. 14 presents simulation showing the V-shaped patterns for two hollow-core optical fibers 100 having different cladding inner diameters. Also shown in FIG. 14 are V-shaped curve 1401, V-shaped curve 1402, V-shaped curve 1411, and V-shaped curve 1412, similar to V-shaped curves 1001, 1002 discussed above, which are estimations obtained by taking the optical path difference between the optical path 1110 through the capillary and the minimum optical path 1120 from the glass-air interface formed by the inner surface 111 of the cladding 110 or the inner surface 121 of the capillary 120. Specifically, V-shaped curve 1401 and V-shaped curve 1402 are associated with a hollow-core optical fiber 100 having a cladding inner diameter of 70 μm, with the V-shaped curve 1401 obtained using the minimum optical path 1120b that meets the glass-air interface defined by the inner surface 121 of the capillary 120, and the V-shaped curve 1402 obtained using the minimum optical path 1120a that meets the glass-air interface defined by the inner surface 111 of the cladding 110. The V-shaped curve 1411 and V-shaped curve 1412 are associated with a hollow-core optical fiber 100 having a cladding inner diameter of 120 μm, with the V-shaped curve 1411 obtained using the minimum optical path 1120b that meets the glass-air interface defined by the inner surface 121 of the capillary 120, and the V-shaped curve 1412 obtained using the minimum optical path 1120a that meets the glass-air interface defined by the inner surface 111 of the cladding 110.

As shown in FIG. 14, the larger cladding inner diameter leads to sharper V-shaped curves 1411, 1412 than the V-shaped curve 1401, 1402 of the smaller cladding inner diameter. Therefore, the shapes of the V-shaped curves can be utilized to determine the inner diameter of the cladding 110.

### V-Shaped Curve Proximation

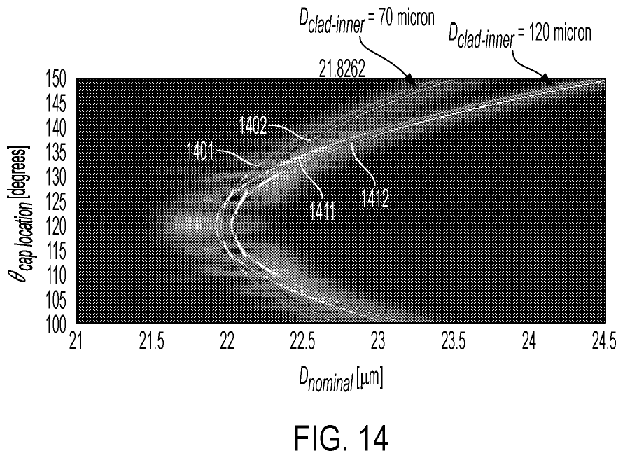

The numerically simulated V-shaped patterns of FIG. 12 can be approximated by the following analytical equations:

$$I ( {θ}_{cap} , λ ) = {\{ cos [ \frac{( {L}_{o p , cap} ( {θ}_{cap} ) - {L}_{o p , c l - surface , m i n} ) {k}_{0}}{2} ] \}}^{2} \qquad ( 24 )$$

$$I ( {θ}_{cap} , λ ) = {\{ cos [ \frac{( {L}_{o p , cap} ( {θ}_{cap} ) - {L}_{o p , cap - surface , m i n} ) {k}_{0}}{2} ] \}}^{2} \qquad ( 25 )$$

where k₀=2π/λ. The analytical Equation (24) and/or Equation (25) allow for simplified estimation of parameters of the hollow-core optical fiber 100, including the inner diameter of the cladding 110. It is noted that either one of the analytical Equation (24) and/or the analytical Equation (25) can be used for estimating the intensity distribution as there is only a slight offset between the calculations with the numerically calculated spectra within the offset. FIG. 15A represents the calculated intensity distribution using the analytical Equation (24), exhibiting close agreement with the numerically calculated spectra of FIG. 15B that are obtained using the path integral method.

### Determining Capillary/Cladding Intersection Angle

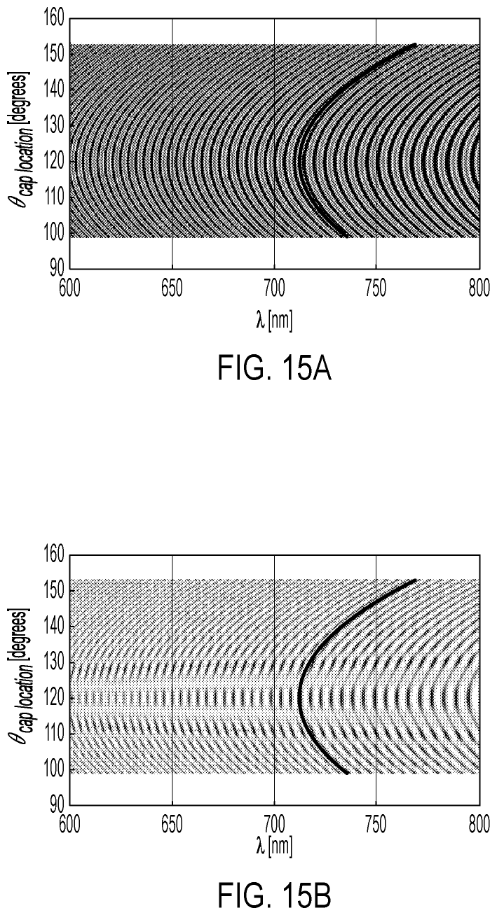

The inventors have further discovered that by utilizing the interference spectra, the intersection angle (or fusion angle) between the capillary 120 and the cladding 110 can be determined. FIG. 16 is a scanning electron microscope image of a portion of the hollow-core optical fiber 100 showing the capillary/cladding interface. The portion of the capillary 120 attached or fused to the cladding 110 extends between intersection points 132a, 132b. The intersection angle α between the capillary 120 and cladding 110 is defined as an angle between a tangent to the inner surface 111 of the cladding 110 and a tangent to the outer surface 122 of the capillary 120 at the intersection points 132a, 132b.

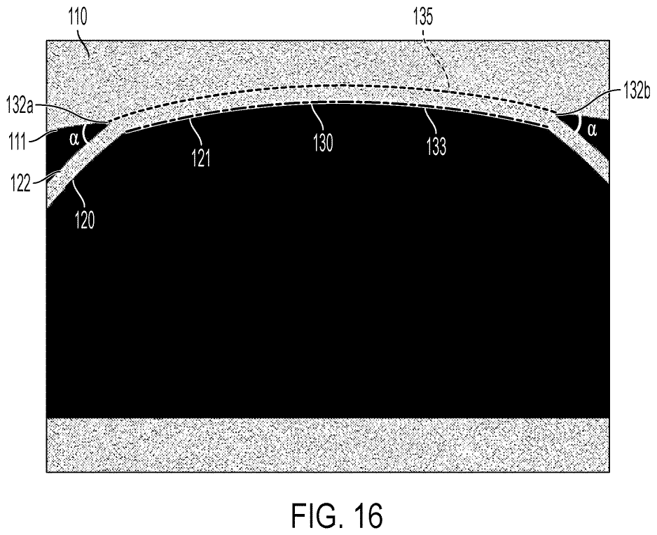

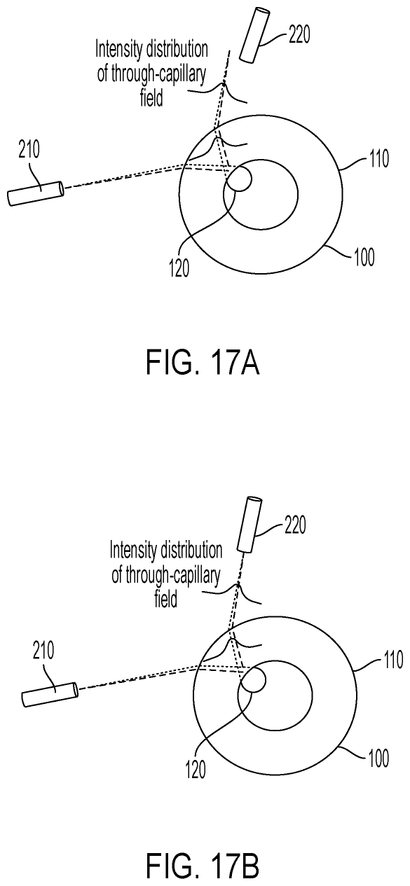

FIGS. 17A and 17B schematically illustrate beam propagation from the light source 210 to the photodetector 220 via the hollow-core optical fiber 100. As shown in FIGS. 17A and 17B, light that passes through and exits the capillary 120 expands as a gaussian beam. FIG. 18 shows an angular intensity distribution of a V-shaped pattern as a function of the nominal diameter Dₙₒₘᵢₙₐₗ. The beam intensity distribution is impressed on the angular intensity distribution of the V-shaped pattern. Peak of the angular intensity distribution of the V-shaped pattern indicates the angle at which the through-capillary field exits the capillary 120. In FIG. 18, the maximum intensity occurs at an angle of 127 degrees, which is not located at the apex (or left most point) of the V-shaped pattern at 136 degrees. This shift of the peak intensity occurs because the photodetector 220 is not aligned at the maximum peak intensity point of the light that exits the capillary 120, as shown in FIG. 17A.

To obtain the exit angle of the beam from the capillary 120, the angular location of the photodetector 220 is adjusted to the configuration shown in FIG. 17B such that the angular intensity distribution in FIG. 18 becomes symmetric with respect to apex of the V-shaped pattern. In some embodiments, the angular location of the light source 210 may be adjusted alternative or in addition to the angular location of the photodetector 220 to achieve a symmetrical intensity distribution. Based on the adjusted angular location of the photodetector 220 and/or the light source 210 and the angular location of the capillary 120, the exit angle of the beam from the capillary 120, which corresponds to the intersection angle α between the capillary 120 and cladding 110, can be determined.

Although not required, positioning the photodetector 220 at the angular location that results in a symmetrical angular intensity distribution can facilitate the measurements and subsequent determination/estimation of the various parameters of the hollow-core optical fiber 100 based on the measurements. Thus, in some embodiments, for characterizing a particular hollow-core optical fiber 100, the angular location of the photodetector 220 may be first adjusted such that the measured intensity spectra may be symmetrical, and then the parameters of the hollow-core optical fiber 100 may be determined or estimated based on measurements taken by the photodetector 220 at such angular location.

### Determining Capillary/Cladding Overlap Width and Overlap Depth

Given the intersection angle α between the capillary 120 and cladding 110, the diameter d_{cap} of the path with length L_{cap} through the capillary 120, and the inner diameter of the cladding 110, the intersection points 132a, 132b and the distance between the intersection points 132a, 132b (also referred to overlap width between the capillary 120 and the cladding 110) can be numerically calculated. It should be noted that although the diameter d_{cap} of the path with length L_{cap} through the capillary 120 is not exactly the same as the diameter of the outer surface 122 of the capillary 120 (the diameter d_{cap} of the path with length L_{cap} through the capillary 120 is greater than the inner diameter of the capillary 120 and less than the outer diameter of the capillary 120 and is about an average of the inner and outer diameters of the capillary 120), the diameter d_{cap} of the path with length L_{cap} through the capillary 120 can be approximated as the outer diameter of the capillary 120 for calculating the intersection points 132a, 132b locations and the distance therebetween for characterizing the overlap width between the cladding 110 and the capillary 120. Additionally, the overlap depth between the capillary 120 and the cladding 110 can be numerically calculated based on the intersection angle α between the capillary 120 and cladding 110, the diameter d_{cap} of the path with length L_{cap} through the capillary 120, and the inner diameter of the cladding 110.

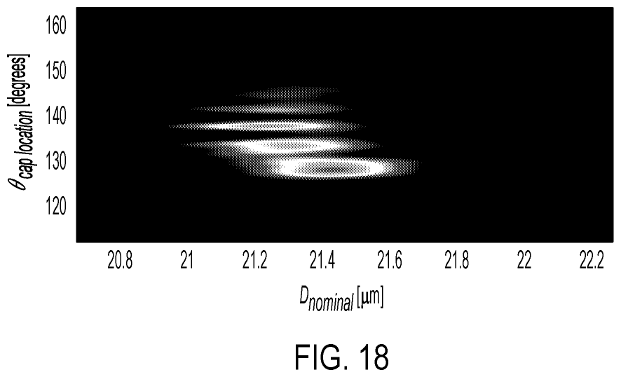

FIG. 19 schematically illustrates a capillary 120a tangentially touching (and thus, not overlapping with) the cladding 110a, and a capillary 120b overlapping with the cladding 110b and the overlap width and overlap depth therebetween. Each of the capillaries 120a, 120b is represented by a circle having a diameter that correspond to the diameter d_{cap} of the path with length L_{cap} through the capillary 120 as discussed above. It should be noted that although FIG. 19 schematically illustrates that the capillary 120b penetrates into the cladding 110b for the purpose of illustrating the overlap width and overlap depth, the capillary 120b is not embedded in the cladding 110b; rather, the capillary 120b and the cladding 110b may form a fused capillary/cladding interface which will be discussed in more detail below.

As discussed above, the overlap width corresponds to the distance between the intersection points 132a, 132b, as also shown in FIG. 19. The overlap depth corresponds to the radially outward shift of the capillary 120b from the capillary 120a, which can be numerically calculated based on the intersection angle α between the capillary 120 and cladding 110 or cladding inner diameter D_{clad_inner}, the diameter d_{cap} of the path with length L_{cap} through the capillary 120, and the overlap width.

### Characterizing Capillary/Cladding Interface Using Effective-Interface Capillary

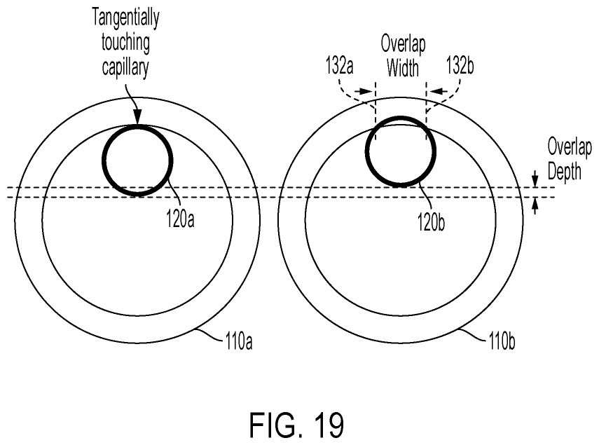

As shown in the SEM image of FIG. 16, the inner surface 121 of the portion of the capillary 120 attached or fused to the cladding 110 can fit an arc of circle with a diameter greater than the inner diameter of the capillary 120 and less than the inner diameter of the cladding 110. Therefore, the capillary/cladding interface can be characterized by an effective-interface capillary with an effective-interface-capillary inner diameter and effective-interface-capillary outer diameter. The section of the effective-interface-capillary 130 at the capillary/cladding interface is marked by two parallel arcs 133, 135 in FIG. 16. The effective-interface-capillary inner diameter corresponds to the diameter of the arc 133, and the effective-interface-capillary outer diameter corresponds to the diameter of the arc 135. FIG. 20 schematically illustrates the cladding 110 and the effective-interface capillary 130 in full tubular form, while the capillary 120 is not shown in FIG. 20.

The inventors have discovered that the interference patterns, such as the interference patterns shown in FIGS. 9, 10, and/or 14, can further be utilized to determine the parameters of the effective-interface capillary 130. Specifically, the inventors have discovered that the effective-interface-capillary inner diameter at least in part determines select features of the interference patterns. Referring to FIGS. 9, 10, and/or 14, the interference patterns each include a plurality of intensity islands forming the V-shaped pattern. In some embodiments, the location (e.g., angular location), size (e.g., width, length), distribution (e.g., number of intensity islands distributed over an angular range), etc., can be utilized to determine at least the effective-interface-capillary inner diameter of the effective-interface capillary 130. For example, the detected interference patterns represented by a plurality of intensity islands may be compared to simulated and/or calculated interference patterns each represented by a plurality of simulated intensity islands associated with a predetermined effective-interface-capillary inner diameter. Using the intensity islands to determine or estimate the effective-interface-capillary inner diameter may provide a more accurate result as the intensity islands allows for multi-factor comparison between the detected and simulated interference patterns, e.g., comparison between locations (e.g., angular locations), sizes (e.g., widths, lengths), distributions (e.g., numbers of intensity islands distributed over various angular ranges), etc., of the intensity islands.

Based on the effective-interface-capillary inner diameter exacted from the interference pattern and the distance between the intersection points 132a, 132b, the effective-interface-capillary outer diameter and the radial location of the centerline 131 of the effective-interface capillary 130 (i.e., the distance between the centerline 131 of the effective-interface capillary 130 and the centerline 101 of the hollow-core optical fiber 100) can be determined. Further, as shown in FIG. 20, an effective fusion distance of the effective-interface capillary 130 into the cladding 110 can be determined by:

Effective fusion distance=(R_{cap_effective_outer}+R_{cap_effective_center})−R_{inner_clad} (26)

where R_{cap_effective_outer} is the outer radius of the effective-interface capillary 130, R_{inner_clad} is the inner radius of the cladding 110, and R_{cap_effective_center} is the distance from the centerline 101 of the hollow-core optical fiber 100 to the centerline 131 of the effective-interface capillary 130.

Exemplary Comparison between Simulated Results and Measured Results

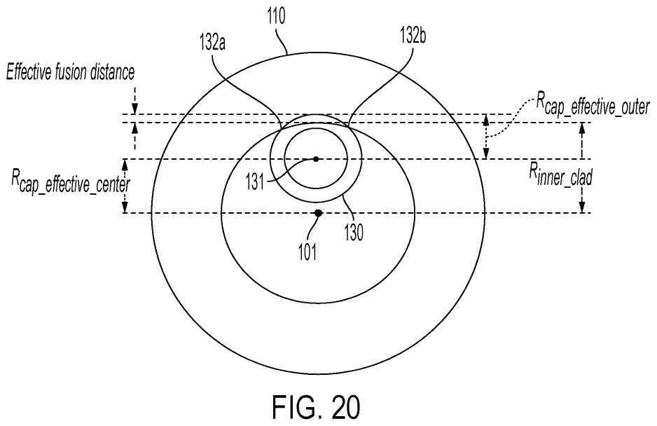

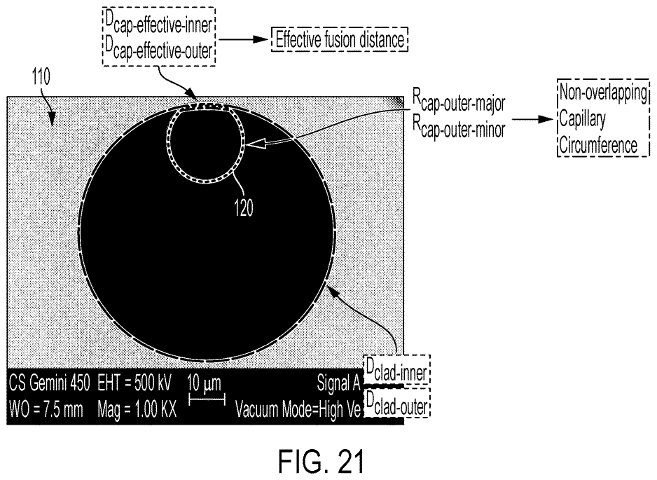

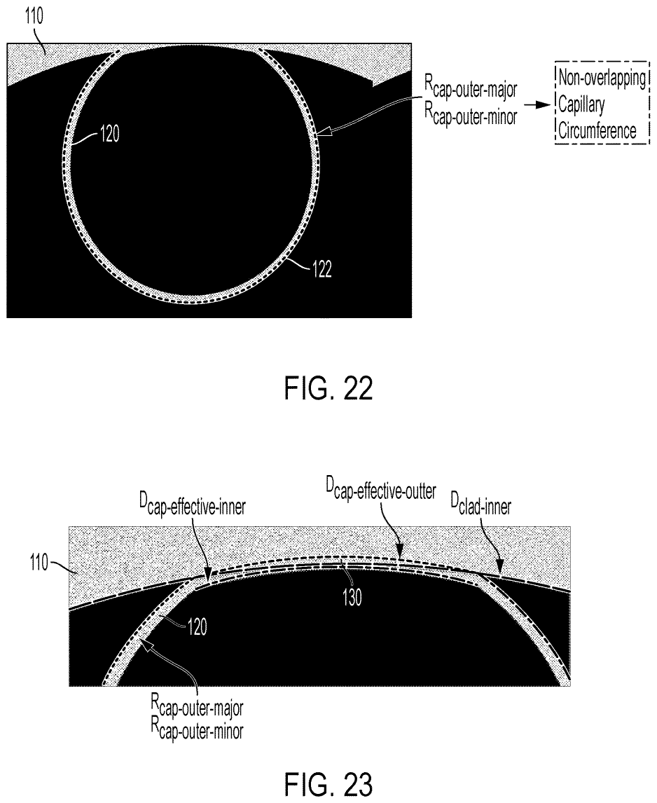

FIG. 21 is a scanning electron microscope (SEM) image showing the capillary 120 fused to the cladding 110. FIG. 22 is an enlarged portion of the SEM image of FIG. 21 showing the non-overlapping outer circumference of the unfused portion of the capillary 120 (defined by the outer surface 122 of the capillary 120) fitted with an ellipse having a major radius R_{cap_outer_major} and a minor radius R_{cap_outer_minor}. FIG. 23 is an enlarged portion of the SEM image of FIG. 21 showing the capillary/cladding interface.

Based on the SEM image, the cladding inner diameter D_{clad_inner}, the cladding outer diameter D_{clad outer} (not shown in FIGS. 21-23), the effective-interface-capillary inner diameter R_{cap_effective_inner}, the effective-interface-capillary outer diameter R_{cap_effective_outer}, the effective fusion distance, the major radius R_{cap_outer_major}, and the minor radius R_{cap_outer_minor}, and the non-overlapping capillary circumference can be measured or calculated.

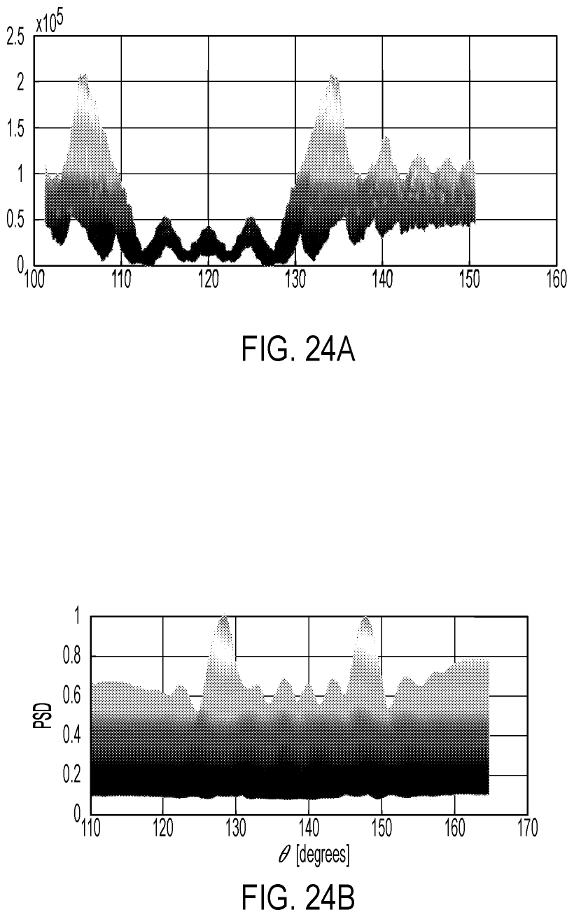

With the values of these parameters of the cladding 110, the actual capillary 120, and the effective-interface capillary 130, the interference pattern is simulated. FIG. 24A shows the simulation results, the interference pattern of which corresponds well to the experimentally measured interference pattern shown in FIG. 24B. It is noted that the term |E_{base}|² from Equation (3) is not included in the simulated results shown in FIG. 24A (and hence, the intensity difference).

### Fitting Measured Spectra to Simulations for Determining Fiber Parameters

As described above, various parameters of the hollow-core optical fiber can be determined based on and/or correlated to measured interference patterns and/or interference patterns derived or transformed from the measured interference patterns. Further, the simulated interference patterns obtained the simulation method described herein are in high degree of agreement with the measured interference patterns. Thus, one or more database(s) may be established using the simulation method described herein, and the measured interference patterns and/or interference patterns derived from the measured interference patterns may be compared or fitted to the simulated interference patterns in the database(s) to determine the various parameters of the hollow-core optical fiber.

### Example—Cladding Inner Diameter

As a non-limiting example, to determine the cladding inner diameter, a database containing V-shaped patterns and/or V-shaped curves may be established. The database may further contain the correlation between the V-shaped patterns and/or V-shaped curves and the cladding inner diameter. For example, in some embodiments, the database may contain the angle or slope of the V-shaped curves as a function of the cladding inner diameter. The cladding inner diameter can thus be determined by fitting one or more V-shaped patterns and/or V-shaped curves from the simulation database with the measured interference spectra and/or V-shaped patterns and/or V-shaped curves derived from the measured interference spectra. For example, interference patterns similar to those shown in FIG. 10 and FIGS. 12-15 may be measured or derived from the measured interference spectra, and V-shaped patterns and/or V-shaped curves from the database may be fitted to the measurements and/or derivatives therefrom to determine the cladding inner diameter of the hollow-core optical fiber being characterized.

### Example—Capillary Cladding Interface

As another non-limiting example, to achieve detailed characterization of the capillary/cladding interface, the effective-interface-capillary inner diameter, the effective-interface-capillary outer diameter, and/or the effective capillary fusion distance into the cladding may be obtained using the simulation method described herein. In some embodiments, simulations may be utilized to establish a database of interference spectra, which may contain V-shaped patterns and/or V-shaped curves. The measured results can be compared with the simulations to obtain the details about the capillary/cladding interface, e.g., the effective-interface-capillary inner diameter, effective-interface-capillary outer diameter, and/or the effective capillary fusion distance.

Although only two examples are described above for using the simulation method described herein to establish one or more databases for characterizing hollow-core optical fibers, any of the parameters of the hollow-core optical fiber described herein may be determined and/or estimated using the simulations and associated databases described herein. Further, artificial intelligence learning model(s) can be trained using any of the simulation databases described herein for determining and/or estimating the parameters of the hollow-core optical fiber.

### Characterization During Draw

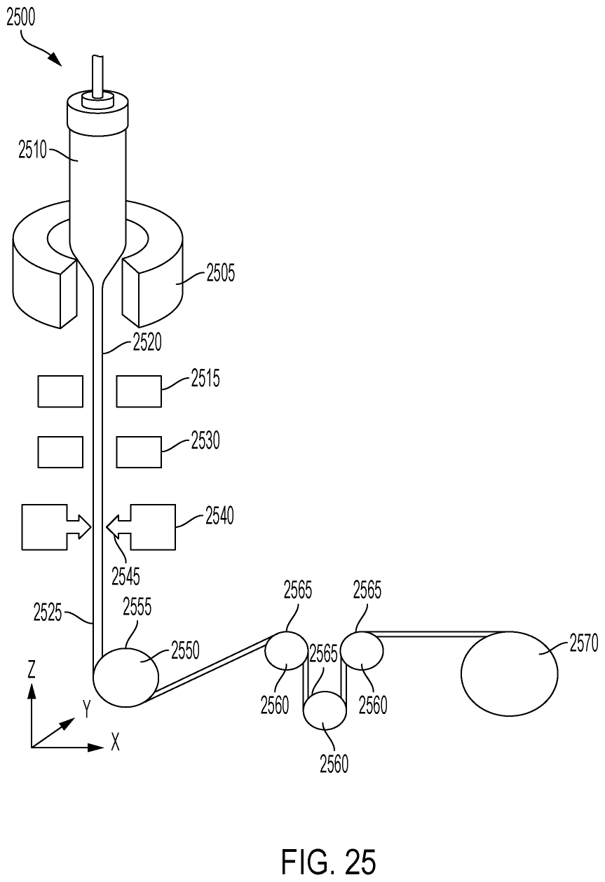

FIG. 25 schematically illustrates an exemplary process 2500 for drawing a hollow-core optical fiber from a hollow-core preform 2510. The drawing system 2500 may include a furnace 2505 for heating the hollow-core preform 2510. The furnace 2505 may be disposed in a draw tower. In some embodiments, the furnace 2505 may include a heater such that the hollow-core preform 2510 is heated and drawn into a hollow-core optical fiber 2520 as the hollow-core preform 2510 is lowered towards the heater.

The drawing system 2500 may further include a non-contact measurement system 2515 for characterizing the various dimensions of the drawn bare hollow-core optical fiber 2520 that exits the furnace 2505. A cooling station 2530 may reside downstream of the measurement system 2515 and may be configured to cool the bare hollow-core optical fiber 2520. In some embodiments, the measurement system 2515 may reside downstream of the cooling station 2530. A coating station 2540 may reside downstream of the measurement system 2515 and the cooling station 2530 and may be configured to deposit a protective coating material 2545 onto the bare hollow-core optical fiber 2520 to form a coated fiber 2525. A tensioner 2550 may reside downstream of the coating station 2540. The tensioner 2550 may include a surface 2555 that pulls (draws) the coated fiber 2525. A set of guide wheels 2560 with respective surfaces 2565 may reside downstream of the tensioner 2550. The guide wheels 2560 may serve to guide the coated fiber 2525 to a fiber take-up spool 2570 to store the coated fiber 2525.

In some embodiments, the measurement system 2515 may include the system 200 described herein for characterizing the hollow-core optical fiber during the draw. As the bare hollow-core optical fiber 2520 may not be rotated or the rotation thereof may be limited, in some embodiments, the measurement system 2515 may include multiple photodetectors 220 at various angular locations and/or multiple light sources 210 at various angular locations. In some embodiments, the measurement 2515 may be configured to include one or more photodetectors 220 and/or one or more light sources 210 that may be configured to rotate about the centerline of the hollow-core optical fiber 2520. The one or more light sources 210 and the one or more photodetectors 220 may cooperate to measure the various parameters of the hollow-core optical fiber 2515 using the methods described herein. It should be noted that although the measurement system 2515 shown in FIG. 25 is configured for characterizing the bare hollow-core optical fiber without the coating, in some embodiments, the measurement system 2515 may be positioned downstream of the coating station 2540 to characterize the coated hollow-core optical fiber 2525.

It will be apparent to those skilled in the art that various modifications to the preferred embodiments of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A method of characterizing a hollow-core optical fiber comprising a centerline, a cladding, and a capillary a portion of which is fused to the cladding, the method comprising:
directing a light beam from a light source to the hollow-core optical fiber;
detecting, by a photodetector, interference generated at least in part by a portion of the light beam propagating through a path through the capillary, wherein the path through the capillary is defined at least in part by a portion of the capillary not fused to the cladding;
comparing a representation of the detected interference to a representation of simulated interference of a simulated hollow-core optical fiber, wherein the representation of the detected interference comprises at least one of a V-shaped pattern or a V-shaped curve, and wherein the representation of the simulated interference comprises at least one of a V-shaped pattern or a V-shaped curve;
determining, based on the comparison, at least one of a cladding inner diameter, a capillary overlap width, or an effective-interface-capillary inner diameter of the hollow-core optical fiber being characterized;
wherein:
the cladding inner diameter is defined as a radial distance between the centerline of the hollow-core optical fiber and an inner surface of the cladding;
the capillary overlap width is defined as a distance between two intersection points between which the portion of the capillary fused to the cladding extends; and
the effective-interface-capillary inner diameter is defined by an inner surface of the portion of the capillary fused to the cladding.

2. The method of claim, wherein the interference is generated in part by at least one of a portion of the light beam reflected via internal reflection by an inner surface of the cladding of the hollow-core optical fiber or a portion of the light beam reflected via internal reflection by the inner surface of the portion of the capillary fused to the cladding.

3. The method of claim, wherein the effective-interface-capillary inner diameter is less than the cladding inner diameter and greater than a diameter defined by an inner surface of the portion of the capillary not fused to the cladding.

4. The method of claim, further comprising:
rotating the hollow-core optical fiber about its centerline while maintaining a position of the photodetector and a position of the light source stationary relative to the centerline of the hollow-core optical fiber.

5. The method of claim, wherein:
the cladding inner diameter is determined based at least in part on comparing a shape of the at least one V-shaped pattern or V-shaped curve of the detected interference with a shape of the at least one V-shaped pattern or V-shaped curve of the simulated interference.

6. The method of claim, wherein:
the at least one of the V-shaped pattern or the V-shaped curve of the simulated interference is obtained based on the simulated hollow-core optical fiber using a path integral method; and
the simulated hollow-core optical fiber comprises:
a centerline;
a cladding; and
a capillary a portion of which is fused to the cladding;
wherein a diameter defined by an inner surface of the portion of the capillary fused to the cladding is less than a cladding inner diameter and greater than a diameter defined by an inner surface of a portion of the capillary not fused to the cladding; and
wherein the at least one of the V-shaped pattern or the V-shaped curve of the simulated interference is obtained using the path integral method based at least in part on the first diameter.

7. The method of claim, wherein the at least one V-shaped pattern or V-shaped curve of the detected interference comprises at least one of:
a wavelength dependence of an intensity of the detected interference as a function of an angular location of the capillary hollow-core optical fiber; or
a group-delay dependence of the intensity of the detected interference as a function of the angular location of the capillary hollow-core optical fiber.

8. The method of claim, wherein:
the detected interference is represented by a V-shaped pattern showing a wavelength dependence of an intensity of the detected interference as a function of an angular location of the capillary the hollow-core optical fiber; and
the simulated interference is represented by a V-shaped curve, wherein the V-shaped curve is obtained based on one of the following relationships:
$$I ( {θ}_{cap} , λ ) = {\{ cos [ \frac{( {L}_{o p , cap} ( {θ}_{cap} ) - {L}_{o p , c l - surface , m i n} ) {k}_{0}}{2} ] \}}^{2} , or$$
$$I ( {θ}_{cap} , λ ) = {\{ cos [ \frac{( {L}_{o p , cap} ( {θ}_{cap} ) - {L}_{o p , cap - surface , m i n} ) {k}_{0}}{2} ] \}}^{2} ,$$
where:
L_{op,cap}(θ_{cap}) represents a simulated optical path length for light to travel from the light source to the photodetector through the capillary of the simulated hollow-core optical fiber,
L_{op,cl-surface,min} represents a simulated minimum optical path length for light to travel from the light source to the photodetector via internal reflection by an inner surface of the cladding of the simulated hollow-core optical fiber,
L_{op,cap-surface,min} represents a simulated minimum optical path length for light to travel from the light source to the photodetector via internal reflection by the inner surface of the portion of the capillary fused to the cladding of the simulated hollow-core optical fiber,
k₀=2π/λ, and
I(θ_{cap},λ) represents a wavelength λ dependence of an intensity of a simulated interference pattern as a function of an angle θ_{cap} of the capillary of the simulated hollow-core optical fiber.

9. The method of claim, further comprising:
adjusting an angular location of the photodetector about the centerline of the hollow-core optical fiber such that the at least one V-shaped pattern or V-shaped curve of the detected interference having a symmetrical angular intensity distribution; and
determining an intersection angle between the cladding and the capillary of the hollow-core optical fiber based at least in part on the angular location of the photodetector, the intersection angle is defined as an angle between a tangent to the inner surface of the cladding and a tangent to the outer surface of the capillary at one of the intersection points.

10. The method of claim, further comprising at least one of:
determining the intersection angle between the cladding and the capillary of the hollow-core optical fiber is further based at least in part on at least one of the cladding inner diameter or a diameter of the path of the portion of the light beam though the capillary; and/or
determining the overlap width between the cladding and the capillary based at least in part on the intersection angle; and/or
determining at least one of an overlap depth between the cladding and the capillary based at least in part on the intersection angle.

11. The method of claim, wherein:
the detected interference is represented by a V-shaped pattern, wherein the V-shaped pattern represents an intensity distribution of the detected interference as a function of an angular location of the capillary of the hollow-core optical fiber, and the V-shaped pattern of the detected interference pattern comprises a plurality of intensity islands; and
determining the effective-interface-capillary inner diameter is based at least in part on at least one of:
locations of the plurality of the intensity islands;
sizes of the plurality of the intensity islands; or
distribution of the plurality of intensity islands over a range of the angular location of the capillary of the hollow-core optical fiber.

12. The method of claim, wherein the V-shaped pattern comprises at least one of:
a group-delay dependence of the intensity of the detected interference as a function of the angular location of the capillary of the hollow-core optical fiber; or
a nominal path diameter dependence of the intensity of the detected interference as a function of the angular location of the capillary of the hollow-core optical fiber.

13. The method of claim, further comprising:
determining an effective capillary fusion distance into the cladding based on at least one of the effective-interface-capillary inner diameter, the cladding inner diameter, or the capillary overlap width.

14. The method of claim, wherein the representation of the simulated interference is obtained from a database comprising a plurality of representations of a plurality of simulation interferences.

15. A method of characterizing a hollow-core optical fiber comprising a centerline, a cladding, and a capillary a portion of which is fused to the cladding and extends between two intersection points, the method comprising:
directing a light beam from a light source to the hollow-core optical fiber;
detecting, by a photodetector, interference generated at least in part by a portion of the light beam propagating through a path through the capillary in whispering gallery mode and a portion of the light beam reflected via internal reflection by an inner surface of the portion of the capillary fused to the cladding; and
adjusting at least one of an angular location of the light source, an angular location of the photodetector, or an angular location of the capillary of the hollow-core optical fiber about the centerline of the hollow-core optical fiber such that an angular intensity distribution of the detected interference is symmetrical about a maximum intensity of the detected interference.

16. The method of claim, further comprising at least one of:
determining an intersection angle between the cladding and the capillary of the hollow-core optical fiber based at least in part on the at least one of the angular location of the light source, the angular location of the photodetector, or the angular location of the capillary of the hollow-core optical fiber, wherein the intersection angle is defined as an angle between a tangent to an inner surface of the cladding and a tangent to an outer surface of the capillary at one of the intersection points; and/or
determining an inner diameter of the cladding of the hollow-core optical fiber based at least in part on the detected interference, wherein determining the intersection angle is further based at least in part on the inner diameter of the cladding of the hollow-core optical fiber; and/or
determining a distance between the two intersection points between which the portion of the capillary fused to the cladding extends based on the detected interference.

17. A method of characterizing a hollow-core optical fiber comprising a cladding and a capillary, the cladding having a cladding inner diameter, and the capillary comprising an unfused portion that is not fused to the cladding and has a capillary inner diameter and a fused portion that is fused to the cladding and has an effective-interface-capillary inner diameter greater than the capillary inner diameter and less than the cladding inner diameter, the method comprising:
directing a light beam from a light source to the hollow-core optical fiber;
detecting, by a photodetector, interference generated at least in part by a portion of the light beam propagating through a path through the capillary and/or a portion of the light beam reflected via internal reflection by an inner surface of the fused portion of the capillary and adjacent inner surface portions of the cladding not fused to the capillary; and
comparing a representation of the detected interference to a representation of simulated interference of a simulated hollow-core optical fiber, wherein:
the simulated hollow-core optical fiber comprises a simulated cladding and a simulated capillary, the simulated cladding having a simulated cladding inner diameter, and the simulated capillary comprising a simulated unfused portion that is not fused to the simulated cladding and has a simulated capillary inner diameter and a simulated fused portion that is fused to the simulated cladding and has a simulated effective-interface-capillary inner diameter greater than the simulated capillary inner diameter and less than the simulated cladding inner diameter;
the representation of the simulated interference is obtained at least in part by calculating a simulated base field E_{base} based on the following:
E_{base}=E_{cap,section}+E_{cl,section_1}+E_{cl,section_2},
where:
E_{cap,section} represents a simulated capillary field due to internal reflection by a simulated inner surface of the simulated fused portion of the simulated capillary, wherein the simulated inner surface of the simulated fused portion of the simulated capillary defines the simulated effective-interface-capillary inner diameter, and
E_{cl,section_1}+E_{cl,section_2} represents a simulated cladding field due to internal reflection by simulated inner surface portions of the simulated cladding disposed on either side of the simulated fused portion of the simulated capillary;
determining, based on the comparison, the effective-interface-capillary inner diameter of the hollow-core optical fiber being characterized.

18. The method of claim, wherein:
the representation of the detected interference comprise a plurality of intensity islands;
the representation of the simulated interference comprises a plurality of simulated intensity islands; and
determining the effective-interface-capillary inner diameter is based at least in part on at least one of:
comparing locations of the plurality of the intensity islands of the detected interference and locations of the plurality of the simulated intensity islands of the simulated interference;
comparing sizes of the plurality of the intensity islands of the detected interference and sizes of the plurality of the simulated intensity islands of the simulated interference; or
comparing angular distribution of the plurality of the intensity islands of the detected interference to angular distribution of the plurality of the simulated intensity islands of the simulated interference.

19. The method of claim, wherein the representation of the simulated interference comprises at least one of a simulated V-shaped curve or a simulated V-shaped pattern obtained based at least in part on the calculated simulated based field E_{base}.

20. The method of claim, further comprising determining, based on the comparison, at least one of the cladding inner diameter or a capillary overlap width defined as a distance between two intersection points between which the fused portion of the capillary extends.
